(19) United States
(12) Patent Application Publication
(10) Pub. No.: US 2023/0189919 A1
(43) Pub. Date: Jun. 22, 2023

(54) Integrated Electronic Touchscreen Display Footwear

(71) Applicant: Kenneth Martin, Philadelphia, PA (US)

(72) Inventor: Kenneth Martin, Philadelphia, PA (US)

(21) Appl. No.: 17/939,022

(22) Filed: Sep. 7, 2022

Related U.S. Application Data
(60) Provisional application No. 63/290,093, filed on Dec. 16, 2021.

(51) Int. Cl. A43B 3/48; G06F 3/041; F21S 9/02; H05B 47/19

(52) U.S. Cl. CPC A43B 3/48; G06F 3/0412; F21S 9/02; H05B 47/19; G06F 2203/04102; G06F 2203/04105; F21Y 2115/10

(57) ABSTRACT

A shoe with an integrated electronic touchscreen display is provided. The shoe includes a flexible electronic display material having an embedded touch screen, which is operably connected to a rechargeable battery. In one embodiment, the rechargeable battery is secured within a heel of the shoe. In another embodiment, the rechargeable battery is disposed on a detachable outsole having the ability to generate power via static electricity generated by walking to recharge the rechargeable battery. The embedded touch screen may alter the colors or other qualities of the flexible electronic display. In this way, the wearer can customize the outward appearance of their shoes. Some embodiments include a ventilation system for cooling.

### CROSS REFERENCE TO RELATED APPLICATIONS

This application claims the benefit of U.S. Provisional Application No. 63/290,093 filed on Dec. 16, 2021. The above identified patent application is herein incorporated by reference in its entirety to provide continuity of disclosure.

### BACKGROUND OF THE INVENTION

The present invention relates to electronic footwear. More specifically, the present invention provides footwear which includes a flexible electronic display material having an embedded touch screen and a detachable outsole with embedded static electricity charging mechanisms or a removable battery pack concealed in the heel of the footwear.

In a wide array of occasions, the footwear that an individual wears can be a major factor in their appearance. For each type of occasion, an individual will want to wear a different type of footwear both in color and pattern. Additionally, depending on the color of the rest of the individual's clothing, the color of their footwear can often complete the look they are attempting to achieve. For example, when an individual is attending an event that requires a suit, the color of the suit usually will determine what color footwear that the individual will want to wear. Additionally, if an individual wants to wear athletic footwear during a physical activity, then they may want the footwear to match the rest of the clothing they are wearing during the activity.

When attending an event in which the type of footwear is an important factor to your appearance, the individual will typically only have the footwear that they wear to the occasion. However, there are times in which upon arrival to an event an individual will see what other guest are wearing for footwear and may want to change their footwear to appear more conform to others at the event. Although some individuals will bring multiple different types of footwear that they can change into while at the event, it is not overly common for individuals to do such. For these individuals, having to transport different types of footwear to make sure they are available for each occasion can be cumbersome. This limits the individual's ability to change their footwear to an alternate color when at an event.

Some individuals do not have the ability to have a plethora of options when it comes to the color of their footwear. Often, the footwear may be the most expensive part of the outfit. With some pairs costing a few hundred dollars, individuals may be restricted to owning very few types of footwear. With the low total of pairs they own, the options that they may wear to specific events or on certain occasions is limiting, especially when the footwear shares a similar function. Thus, it is difficult for an individual to own enough of a single type of footwear that vary in color to have options when deciding which pair they want to wear for an event.

This is not to say that there are not individuals that are fortunate to own enough pairs of similar types of footwear that vary in color and pattern. Unfortunately, these individuals may have issues of their own from owning a high abundance of footwear. It is common for an individual to lay their shoes on the ground surface of their bedroom or other areas of their home. Typically, these individuals will attempt to have all their footwear in a single location within their home. Having an abundance of footwear can occupy a large area of the individual's home. For the individuals who want to maintain some organization or tidiness in their home, owning a large collection of footwear can make it difficult to maintain such order. Limiting the number of different types of footwear, while still allowing the variety of color, will allow the individual to maintain a desired level of organization.

Therefore, there is a defined need amongst the known prior art references for a type of footwear that will provide users with a shoe with a flexible electronic display and an embedded touch screen that allows wearers to change the color, pattern, or design by simply swiping their finger on the shoe.

### SUMMARY OF THE INVENTION

In view of the foregoing disadvantages inherent in the known types of footwear now present in the known art, the present invention provides footwear that includes a flexible electronic display material having an embedded touch screen and embodiments that include a detachable outsole with embedded static electricity charging mechanisms or a removable battery pack concealed in the heel of the footwear.

It is therefore an object of the present invention to provide footwear that has a flexible electronic display which emits lights and an embedded touch screen that allows for alternating of the color of the lights emitted. When an individual wants their footwear to be a particular color or design, they often will have to own multiple types of footwear to achieve the look they want. However, allowing an individual to have such diversity in appearance while only having to own a single pair of footwear provides a plurality of benefits. Additionally, allowing an individual to alter the color or pattern on the footwear they are wearing by just using their finger to apply a force upon a touch screen embedded on the surface of the footwear will reduce the concerns raised above regarding the need for footwear of varying colors or patterns. Moreover, providing the individual with the ability to alter the color or pattern on the footwear with accessing an application downloaded upon an electronic device further simplifies the process. The present invention allows the alteration of the color or pattern of footwear with ease regardless of what type of color that the individual wants to display.

It is therefore another object of the present invention to provide footwear that contains a simple means of powering the flexible electronic display material and the embedded touch screen. In a first embodiment, a power source for the footwear will come in a removable battery pack placed within the heel of each shoe. The spring loaded removable battery packs will easily be accessible to place within a universal charger prior to use to allow the user a prolonged use of the present invention. Additionally, the spring loaded containment of the removable battery packs within the heel limit the chances that the removable battery packs are ejected from the heel when not desired. In a second embodiment, a power source for the footwear will come in a detachable outsole that may also be connected to a universal charger for powering. Moreover, this embodiment will also contain a static electricity source which generates static electricity from friction that occurs when a user walks against the surface of the ground in use. This will allow for perpetual powering of the footwear if the wearer continues to move.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the integrated electronic shoe.

FIG. 1B shows a partially internal view of an embodiment of the integrated electronic shoe.

FIG. 2 shows a perspective view of an embodiment of an electronic device connected with the integrated electronic shoe.

FIG. 3A shows an exploded side view and a side view of an alternative embodiment of the integrated electronic shoe.

FIG. 3B shows a top view of the outsole of an alternative embodiment of the integrated electronic shoe.

### DETAILED DESCRIPTION OF THE INVENTION

Reference is made herein to the attached drawings. Like reference numerals are used throughout the drawings to depict like or similar elements of the integrated electronic shoe. The figures are intended for representative purposes only and should not be limiting in any respect.

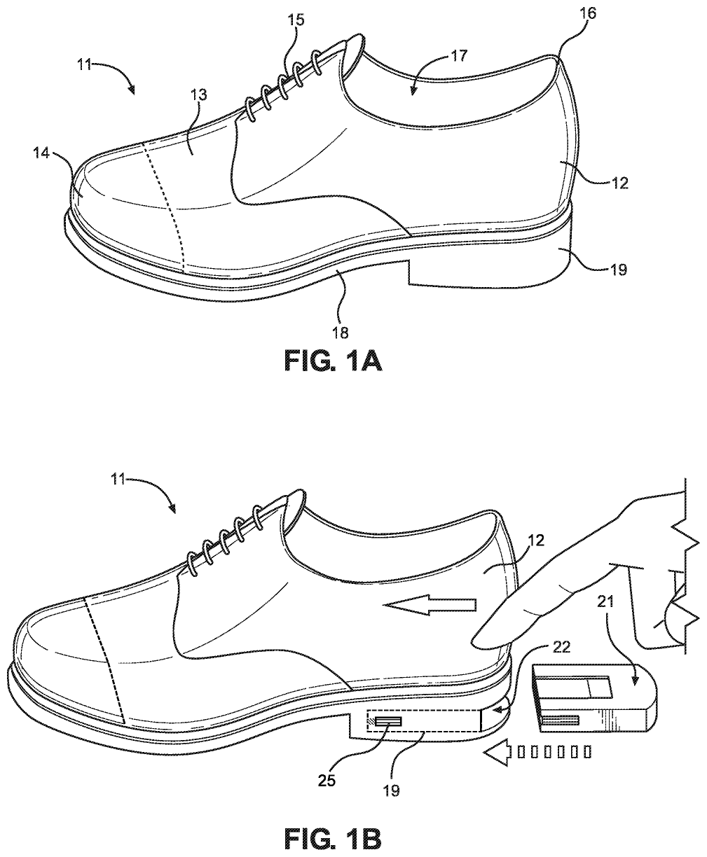

FIG. 1A shows a perspective view of an embodiment of an integrated electronic shoe. The integrated electronic shoe 11 comprises a backstay 16, a pair of quarters 12, a vamp 13, a toe box 14, and an outsole 18. The pair of quarters 12 are disposed on opposing ends of the backstay 16. A front facing 15 connects ends of the pair of quarters 12 opposite the backstay 16. The front facing 15 further comprises a tongue and a lacing system. In one embodiment, the lacing system includes a plurality of apertures and a lace threaded therethrough. The pair of quarters 12 and backstay 16 define an opening 17. A wearer may place their foot through the opening 17 to secure the integrated electronic shoe 11 to their foot. An end of the pair of quarters 12 distal from the backstay 16 is coupled with the vamp 13. The vamp 13 is sandwiched between the pair of quarters 12 and the toe box 14. The toe box 14 is rounded to accommodate for the toes of a wearer. The outsole 18 is connected to the backstay 16, the pair of quarters 12, the vamp 13, and the toe box 14, thus defining the electronic shoe 11. A heel 19 is disposed on a bottom side of the outsole 18. The heel 19 is located towards the backstay 16.

The electronic shoe 11 includes a flexible electronic display and an embedded touch screen. The flexible electronic display is disposed on the pair of quarters 12, the vamp 13, and the toe box 14. The flexible electronic display comprises a plurality of LED lights. The plurality of LED lights will illuminate through the pair of quarters 12, the vamp 13, and the toe box 14. The flexible electronic display will emit a plurality of colors. The flexible electronic display allows the integrated electronic shoe 11 to conform its shape during the normal course of use. The conforming of the integrated electronic shoe 11 while walking will not damage the flexible electronic display. The flexible electronic display will emit the plurality of LED lights coextensively across the pair of quarters 12, the vamp 13, and the toe box 14. In one embodiment, the flexible electronic display of the pair of quarters 12 is independent of the vamp 13 and the toe box 14 and the flexible electronic display of the vamp 13 is independent of the toe box 14.

FIG. 1B shows a partially internal view of an embodiment of an integrated electronic shoe. The integrated electronic shoe 11 includes the heel 19 disposed on the bottom side of the outsole. The heel 19 is positioned to provide support to the wearer while they walk in the integrated electronic shoe. The heel 19 comprises an interior volume 22. A removable battery pack 21 may be secured within the interior volume 22. In one embodiment, the heel 19 comprises a spring loaded locking device 25 that secures the removable battery pack 21 within the interior volume 22. When secured, an individual will apply a force from their finger onto the removable battery pack 21, partially depressing the removable battery pack 21 further into the interior volume 22, then when the individual releases their finger the removable battery pack 21 will eject from the heel 19. When a user wants to insert the removable battery pack 21 into the interior volume 22 of the heel 19, the user will push the removable battery pack 21 until the spring loaded locking device 25 engages, thus securing the removable battery pack 21 thereon. In one embodiment, the spring loaded locking device 25 engages with embedded grooves of the removable battery pack 21. An exterior surface of the removable battery pack 21 rests flush with an exterior surface of the heel 19 when secured within the interior volume 22.

When ejected, the removable battery pack 21 may be coupled to a universal charging device. The universal charging device will supply power to the removable battery pack 21. When secured within the interior volume 22 of the heel 19, the removable battery pack 21 is operably connected to the flexible electronic display and the embedded touch screen. When the removable battery pack 21 is secured within the interior volume 22, the removable battery pack 21 will power the flexible electronic display and the embedded touch screen of the integrated electronic shoe 11. The removable battery pack 21 is further connected to a wireless transceiver. The wireless transceiver may be operably connected to an electronic device.

The integrated electronic shoe 11 includes the embedded touch screen. In one embodiment, the embedded touch screen is disposed on at least one of the pair of quarters 12. In another embodiment, the embedded touch screen is disposed on the toe box of the integrated electronic shoe 11. The embedded touch screen is operably connected to the flexible electronic display. An individual may apply their finger across the embedded touch screen to adjust the color of the LED that is emitted from the flexible electronic display. When the desired color is displayed from flexible electronic display, the user will release their finger from the embedded touch screen.

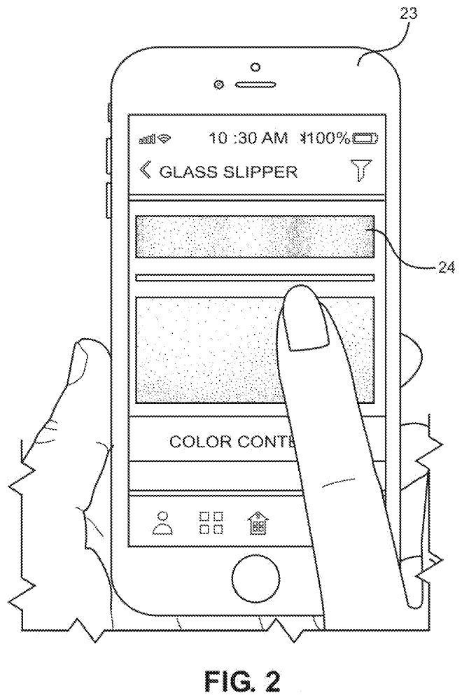

FIG. 2 shows a perspective view of an embodiment of an electronic device connected with an integrated electronic shoe. The integrated electronic shoe may connect to an electronic device 23 via the wireless transceiver. The electronic device 23 further includes an application 24 whereby an individual may launch the application 24 on the electronic device 23. The application 24 may title the connected pair of integrated electronic shoes to allow the user to differentiate from other pairs of integrated electronic shoes that may be linked to the application 24. The wireless transceiver is connected to the embedded touch screen through the connection of the removable battery pack. The pair of integrated electronic shoes connected to the application 24 permits the user to alter the color of light emitted by the LED of the flexible electronic display via the application 24. The application 24 on the electronic device 23 alters the emitted LED of the pair of integrated electronic shoes without using the embedded touch screen. Additionally, the application 24 allows the user to alternate the pattern that is emitted from the flexible electronic display.

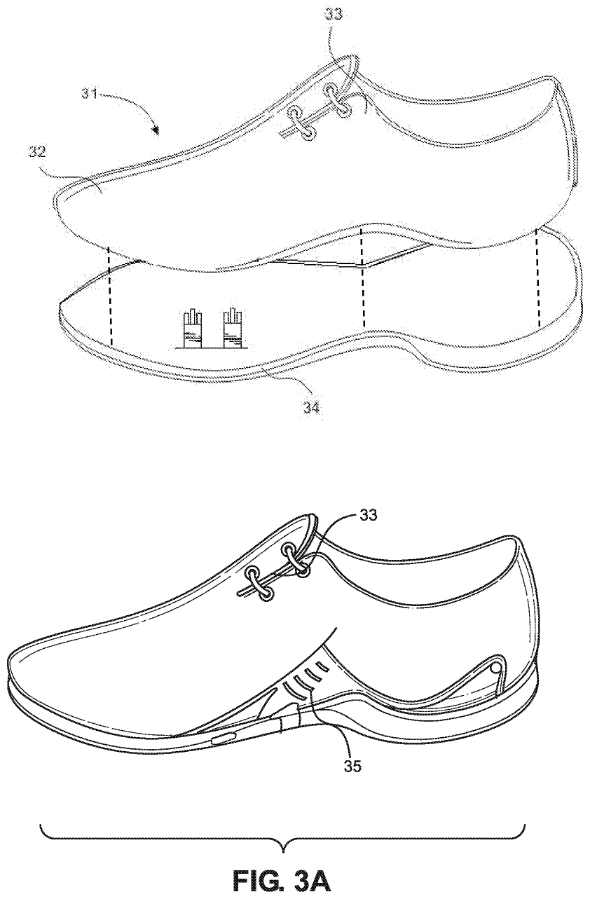

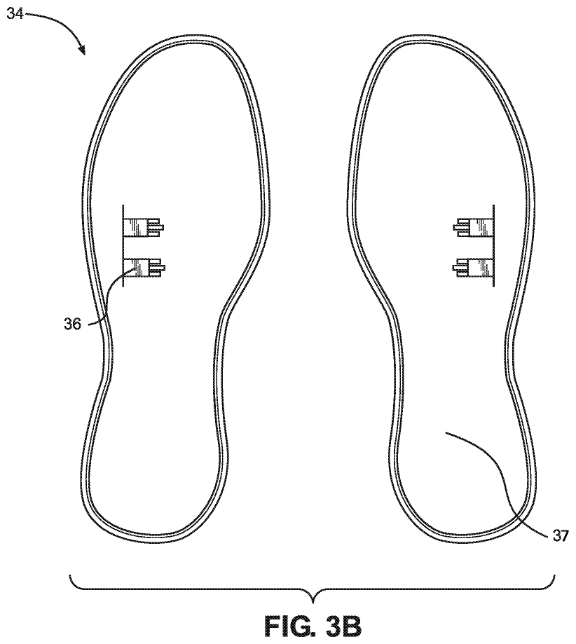

FIG. 3A shows an exploded side view and a side view of an alternative embodiment of an integrated electronic shoe. The integrated electronic shoe 31 includes a backstay, a main body 32, and a detachable outsole 34. The main body 32 extends from the backstay towards a toe of the integrated electric shoe. In one embodiment, the main body 32 is configured as a running shoe. In another embodiment, the main body 32 is configured as a tennis shoe. In yet another embodiment, the main body 32 is configured as a basketball sneaker. The backstay and the main body 32 define an opening. The detachable outsole 34 defines the heel of the integrated electronic shoe 31. A wearer may place their foot through the opening to secure the integrated electronic shoe 31 to their foot. The main body 32 includes a front facing 33. The front facing 33 is positioned at the opening. The front facing 33 further comprises a tongue and a lacing system. In one embodiment, the lacing system includes a plurality of apertures and a lace threaded therethrough. In another embodiment, the lacing system includes a system of hook and loop fasteners. In yet another embodiment, the lacing system includes an elastic band threaded through a plurality of apertures. In another embodiment, the lacing system includes a click-style closure fastener.

Some embodiments of the integrated electronic shoe 31 also includes a ventilation system 35. The ventilation system 35 is positioned along a base of the main body 32 and above the detachable outsole 34. Air is permitted to pass through the ventilation system 35 to reduce a build-up of heat within the integrated electronic shoe 31 while in use. Moreover, the ventilation system 35 cools the foot of the wearer therein when they are performing active movements while the integrated electronic shoe 31 is in use.

The electronic shoe 31 includes a flexible electronic display and an embedded touch screen. The flexible electronic display is disposed on the main body 32. The flexible electronic display comprises a plurality of LED lights. The plurality of LED lights will illuminate through the main body 32. The flexible electronic display will emit a plurality of colors. The flexible electronic display allows the integrated electronic shoe 31 to conform its shape during the normal course of use. The conforming of the integrated electronic shoe 31 while walking will not damage the flexible electronic display.

FIG. 3B shows a top view of the outsole of an alternative embodiment of an integrated electronic shoe. The integrated electronic shoe includes a detachable outsole 34. The detachable outsole 34 is composed from a flexible material. The detachable outsole 34 comprises a main member 37 and an electronic component 36. The main member 37 includes an elevated perimeter edge. The elevated perimeter edge provides connects the detachable outsole 34 to the base of a secured insole of the integrated electronic shoe. The electronic component 36 is centrally located on the main member 37. The electronic component 36 comprises an internal control board, a wireless transceiver, a rechargeable battery, and at least one electrical clip. The internal control board is operably connected to the flexible electronic display and the embedded touch screen. The secured insole of the integrated electronic shoe operably connects to the internal control board to supply power from the rechargeable battery to the flexible electronic display and the embedded touch screen. The wireless transceiver may operably connect the integrated electronic shoe to an electronic device.

The rechargeable battery generates power through a static electricity source. The static electricity source is operably connected to the rechargeable battery and the other electronic components 36. The static electricity source generates static electricity from friction that occurs when a user walks against the surface of the ground. The surface of the ground causes a transfer of electrons leaving a positive charge of the surface of the ground and gathering in the static electricity source within the detachable outsole 34. This transfer of electrons is called a triboelectric charge. The triboelectric charge will occur when the integrated electronic shoe are in use. Thereby the static electricity generated will recharge the rechargeable battery and supply power to the electronic components 36. The at least one electrical clip provides an additional connecting point between the rechargeable battery and the secured insole of the integrated electronic shoe to supply the power to the flexible electronic display and the embedded touch screen. Additionally, the at least one electrical clip may be coupled to a universal charging device to provide an alternative means of supplying power to the rechargeable battery.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An integrated electronic shoe, comprising:
a backstay;
a pair of quarters disposed on opposing sides of the backstay;
wherein the backstay and the pair of quarters defines an opening;
a front facing connected to each quarter of the pair of quarters;
a vamp affixed to the pair of quarters;
a toe box disposed on the vamp, whereby the vamp is sandwiched between the pair of quarters and the toe box;
an outsole connected to the backstay, the pair of quarters, the vamp, and the toe box;
a heel disposed on a bottom side of the outsole near the backstay;
a removable battery pack placed within the heel;
wherein the pair of quarters, the vamp, and the toe box include a flexible electronic display;
wherein the pair of quarters further comprises an embedded touch screen;
the removable battery pack is operably connected to the flexible electronic display and the embedded touch screen; and
a wireless transceiver is connected to the removable battery pack.

2. The integrated electronic shoe of claim 1, wherein the heel comprises a spring loaded locking device that secures the removable battery pack therein.

3. The integrated electronic shoe of claim 1, wherein the embedded touch screen is located on at least one quarter of the pair of quarters.

4. The integrated electronic shoe of claim 1, wherein the embedded touch screen is located on the toe box.

5. The integrated electronic shoe of claim 1, wherein the flexible electronic display is a LED.

6. The integrated electronic shoe of claim 1, wherein the flexible electronic display emits a plurality of colors.

7. The integrated electronic shoe of claim 1, wherein the embedded touch screen alters the color of the flexible electronic display.

8. The integrated electronic shoe of claim 1, wherein the wireless transceiver couples with an electronic device to alter the color of the flexible electronic display.

9. An integrated electronic shoe, comprising:
a backstay;
a main body extending from the backstay;
wherein the backstay and the main body defines an opening;
a secured insole coupled to the backstay and the main body;
a detachable outsole connected to the secured insole;
the detachable outsole defining a heel of the integrated electronic shoe;
wherein the main body includes a flexible electronic display and an embedded touch screen;
the secured insole operably connects to an internal control board of the detachable outsole;
the internal control board is operably connected to the flexible electronic display and the embedded touch screen;
a wireless transceiver connected to the internal control board; and
the detachable outsole comprises a rechargeable battery that operably connects to the secured insole via at least one electrical clip.

10. The integrated electronic shoe of claim 9, wherein the detachable outsole is composed from a flexible material.

11. The integrated electronic shoe of claim 9, wherein the main body further comprises a ventilation system.

12. The integrated electronic shoe of claim 9, wherein the rechargeable battery generates power from a static electricity source.

13. The integrated electronic shoe of claim 9, wherein the flexible electronic display is a LED.

14. The integrated electronic shoe of claim 9 wherein the flexible electronic display emits a plurality of colors.

15. The integrated electronic shoe of claim 9, wherein the embedded touch screen alters the color of the flexible electronic display.

16. The integrated electronic shoe of claim 9, wherein the wireless transceiver couples with an electronic device to alter the color of the flexible electronic display.
